(19) United States
(12) Patent Application Publication
(10) Pub. No.: US 2013/0207296 A1
(43) Pub. Date: Aug. 15, 2013

(54) PROCESS FOR MANUFACTURING PELLETS AND PELLETS OBTAINED BY THE PROCESS

(71) Applicant: Frank Etienne, Mougins (FR)

(72) Inventor: Frank Etienne, Mougins (FR)

(73) Assignee: TECH@PI, Valbonne Sophia-Antipolis (FR)

(21) Appl. No.: 13/640,143

(22) PCT Filed: Apr. 22, 2011
(86) PCT No.: PCT/FR2011/000247

§ 371 Date: Mar. 19, 2013

(30) Foreign Application Priority Data
Apr. 23, 2010 (FR) 1001739

(51) Int. Cl. B29B 9/12

(52) U.S. Cl. CPC B29B 9/12
USPC 264/121

(57) ABSTRACT

The invention relates to a process for manufacturing pellets from wet biomass residues having a high water content of between 25% and 80% comprising the steps of a) charging the homogenate of wet biomass residues into a receptacle, b) drying the wet biomass residues in a dryer and c) converting the dry biomass residues in a pelleting press comprising a steel die pierced with holes and a steel rotor comprising notched wheels made of steel, in order to obtain the pellets, said process comprising/being characterized in that a step of drying the wet biomass residues is carried out at the same time as the pellet-conversion step at a temperature between 65° C. and 95° C. in a pelleting press coupled, in a closed circuit, to a dryer with air/air exchange comprising a pelleting press/dryer communication by-pass. The invention also relates to the pellets of plant or wood origin obtained by the process described and having a compaction of greater than 750 kg/m³.

The invention relates to a process for manufacturing pellets, also referred to as granules. The invention further relates to pellets obtained by the manufacturing process implemented therein.

Throughout the ages, Man has always known how to take advantage of the energy that nature placed at his disposal. For centuries, dry plants and wood have been the main energy resources used by Man. This energy was accessible, calorific, and renewable ad infinitum.

Today, by adopting the Kyoto protocol, industrialized countries have committed to reduce greenhouse gas emissions by 20% by 2020 with respect to the levels of 1990. Therefore, the objectives of sustainable development present industrialists, community organizations, and citizens with a threefold challenge: energy, environmental, and economic.

Heating with pellets has numerous advantages, making it the most efficient, economical and ecological heating mode. The high density of this fuel, combined with a low moisture rate, provides it with a very high energy efficiency. The yield of pellet-heating apparatuses is indeed exceptional since it is comprised between 85 and 90% for boilers and between 80 and 90% for furnaces. Thus, only 10% of the pellet is lost in the form of smoke and ashes. Pellets cost 25% less than natural gas and twice less than fuel-oil. In addition, because it is energy independent, the cost of this bio-fuel remains permanently stable, unlike fossil fuels.

Pellets are some of the most ecological bio-fuels. They come from plant and/or wood residues and consequently do not require the cutting of trees. Pellets are manufactured without glue or additives and are considered to be clean, non-polluting fuels. The carbon balance of the pellets is equivalent to zero since the carbon dioxide which they produce during combustion is absorbed during tree growth. Similarly, their environmental impact is very low since these products are manufactured and consumed locally, unlike fuels (oil, gas) requiring substantial transportation. Finally, pellets enable fighting against the greenhouse effect and help achieve the European objectives set at the Grenelle Environment Forum, i.e., the use of 23% of renewable energy by 2020.

Heating with pellets is thus the best fuel to obtain efficient, economical, and environment-friendly heat.

In the context of environment friendliness, it appears necessary to implement processes for manufacturing pellets which are consistent with the requirements laid down. Processes for manufacturing pellets must therefore be economical in terms of energy to produce pellets with high calorific value, while being environment friendly.

There are a certain number of known processes for manufacturing pellets. Nowadays, it is conventional to manufacture pellets in several steps, all the steps including one step involving very high energy consumption for drying the biomass.

The patent application WO 2006/081645 discloses a process for manufacturing pellets from biomass residues. The steps described in this process comprise loading biomass residues into a container, drying said residues in a drying system by means of hot air, refining the dried biomass residues, and separating the residues into two fractions in order to press and extrude the suitable residues in a preforming press or pelletizer to form pellets. The pellets obtained via the described process have a compaction comprised between 550 and 750 Kg/m³.

The patent application EP 2 157 158 discloses a process for manufacturing pellets from large pieces of fibrous materials. The crude material is first chopped, then dried, and subsequently transformed into pellets in a pelletizer.

The patent application U.S. Pat. No. 4,324,561 discloses a process for manufacturing pellets which consists of treating the biomass by a first drying step to obtain a material having a 12% moisture rate, a second grinding step, a third additional drying step at a temperature of 90 to 121° C. for better plasticization of the resins, and finally a fourth step of forming pellets in a pelletizer. Here, the biomass is dried upstream of the pelletizer, twice on the raw material, before passage into the pelletizer.

Therefore, the processes currently known present a major drawback, i.e., they use a lot of energy to dry the biomass by heating before transformation into pellet form. The manufacturing yield by transformation of the biomass into pellets is not optimized.

Consequently, there is today no satisfactory solution for manufacturing pellets with a high calorific value that is both economical in terms of energy used and respects the environment.

The present invention provides a solution that represents considerable progress over the techniques being currently used.

An object of the invention is thus to provide a process for manufacturing pellets that enables the installations used to be energy efficient and respects the environment while producing pellets having a very high compaction and a very high calorific value.

The term “pellets” in the present invention refers to granules of vegetal origin or vegetal pellets comprising ligneous and herbaceous plants, or wood granules. The process for manufacturing pellets according to the invention is described more particularly for manufacturing vegetal pellets, but also applies to the manufacturing of wood granules.

A first object of the invention consists of a process for manufacturing pellets from residues of wet biomass having a high moisture rate comprised between 25 and 80% comprising the steps of:

a) loading the homogenate of wet biomass residues into container,

b) drying the residues of the wet biomass into a dehydrator and

c) transforming dry residues of the biomass in a pelletizer comprising a steel matrix pierced with holes and a steel rotor comprising notched wheels to obtain pellets,

said process being characterized in that the step of drying residues of wet biomass is carried out simultaneously with the step of transforming the residues into pellets at a temperature comprised between 65 and 95° C. in a pelletizer coupled in closed circuit to an air/air exchange dehydrator comprising a pelletizer-dehydrator communication by-pass.

The process according to the invention uses a wet biomass, freshly harvested, without undergoing a prior—particularly costly—drying phase.

The residues of wet biomass come from the upkeep of urban and suburban green spaces whose surfaces and volumes are steadily increasing. They comprise, in particular, the products from urban pruning and side road cleaning, green waste from pruning and grass-cutting, leaves, waste from cut wood, trunks and branches of various trees, homogenates from various plants and shrub- and hedge-size residues from public and private gardens. The residues of wet biomass also comprise horse litter and fermenting vegetal homogenates intended for compost.

The collection of wet biomass is carried out by community organizations and private companies through the year, with more favorable periods in spring and fall. The geographic availability of this biomass is very concentrated and requires no heavy transportation.

Once collected, this wet biomass is simply put under shelter for a certain period of time, if needed, so as to enable it to dry naturally, and thus, to obtain a moisture rate comprised between 25 and 80%. After a variable drying time, which is function of a moisture rate of the collected wet biomass, said wet biomass is ground. The homogenate of the residues of wet biomass is loaded in a container and transported to a delivery cylinder of the pelletizer by an auger.

The step of drying residues of the wet biomass is performed simultaneously with the step of transforming residues into pellets at a temperature comprised between 65 and 95° C. in a pelletizer coupled to an air-air exchange dehydrator comprising a pelletizer-dehydrator communication by-pass.

By “coupled”, one means that the pelletizer is in direct relation with the dehydrator and is located close to the latter or in its vicinity, so that the pellets entering and exiting the pelletizer travel a short distance. The dehydrator is located downstream of the pelletizer in the simultaneous step of transformation into pellets and drying of wet biomass residues.

The temperature of 65 to 95° C. obtained by rotation of the notched steel wheels on the steel matrix enables drying the wet biomass residues during their passage through the holes of the matrix. The homogenate, once pushed toward the matrix by the rotor wheels, is discharged, in the form of spaghetti, outside the matrix in a conduit that empties it in an air/air exchange dehydrator comprising a pelletizer-dehydrator communication by-pass. The homogenate at the exit of the matrix and at the entrance of the dehydrator is brought to a temperature of 65 to 95° C., preferably 70 to 90° C.

The pelletizer used in the process according to the invention is, for example, a Kahl® type pelletizer, enhanced and perfected for the needs of the process.

Therefore, the addition of a homogenate of wet biomass onto the hot pelletizer makes it possible to reduce the operating temperature of the moving mechanical assembly (rotor and matrix) and to dehydrate the wet biomass.

The air/air exchange dehydrator is located close, or even very close to each pelletizer. Thus, the temperature of the homogenate in the pelletizer coupled in closed circuit to the dehydrator enables the homogenate to dry rapidly and to be transformed into pellets. The closed circuit travel in the dehydrator allows for the pellets, still slightly wet, to be transported toward the cylinder head of the pelletizer while getting rid of residual moisture by air/air exchange. The steam is discharged by the opening on top of the dehydrator. Once dried, the pellets are discharged by being drained down due to the outwardly actuated by-pass. This action is adjusted electro-pneumatically.

The combination of temperature in the pelletizer in the area of the matrix and of travel in closed circuit of the homogenate between the dehydrator and the pelletizer is the key element of the invention. Indeed, the steel-against-steel friction of the rotor on the matrix creates substantial heat. This heat constitutes the first means for drying the wet biomass, by absorption of water contained in the biomass. The second drying means is the travel in closed circuit of the homogenate between the pelletizer and the dehydrator which enables optimizing the drying of the pellets by air-air exchange. These two means in combination make it possible to rapidly manufacture pellets having a high calorific value, by optimizing the drying phase of the residues of wet biomass.

In a preferred embodiment of the invention, the drying step simultaneous to the step of transformation into pellets in the pelletizer is performed with a rotor speed on the matrix comprised between 350 and 450 revolutions/minute and a space between the rotor wheels and the matrix of less than or equal to 1/10 mm.

In another preferred embodiment of the invention, the air/air exchange dehydrator is coupled to a pelletizer so as to lower by 8 to 15% the temperature of the incoming pellets so as to re-inject them in the pelletizer by the communication by-pass. A 10% cooling is preferred to optimize global drying.

The dehydrator is an assembly of streamlined metal composed of steel buckets for collecting the biomass extruded through the matrix of the pelletizer. These buckets are fixed to a synthetic belt driven by an electric motor, such as a conveyor. An orifice at the top of the assembly allows for steam to be discharged. The opening in the lower portion allows the biomass coming from the matrix to enter the dehydrator. Another opening in the upper portion allows the material to return toward the cylinder bell. The centrifugal force enables the product thus transported to be pushed back toward the cylinder.

In order to optimize the drying as previously described, the pelletizer and the dehydrator comprise openings allowing for the steam to be discharged. Part of the steam contained in the biomass residues is discharged by a cylinder bell of the non-obturated pelletizer. The other part of the steam contained in the pellets exiting the pelletizer is discharged by an opening in the top of the dehydrator.

As previously described, the pelletizer is coupled to a dehydrator, allowing for optimal drying. This coupling is optimized when there is very little energy loss between the exit and the entrance of the pellets inside the pelletizer. Thus, a length H of the travel of the pellets in the dehydrator is defined. The travel of the pellets exiting the pelletizer over a length H in the dehydrator enables cooling their temperature by about 10%. Naturally, this distance depends on the quantity and moisture rate of the biomass residues at the entrance of the pelletizer, as well as on the power of the motor. One having ordinary skill in the art will know how to adapt this distance as a function of these criteria, of the size of the pelletizer and of the dehydrator.

Thus, according to an embodiment described in example 1, the length H of travel in the dehydrator of the pellets exiting the pelletizer is comprised between 200 and 400 cm. More preferably, the length H is equal to about 350 cm.

In a preferred embodiment according to the invention, the matrix of the pelletizer is pierced with holes having a diameter preferably comprised between 6 and 16 mm.

In the process according to the invention, a specific drying time in the dehydrator is necessary to obtain pellets whose moisture rate is comprised between 5 and 15%, preferably 10%. The drying time is adjusted by an operator as a function of the moisture of the plant at the entrance of the pelletizer as well as the composition thereof (ligneous and herbaceous plants, wood, mixtures, etc.). It is automated by a timer calculating the drying time and the loading time as a function of the criteria hereinabove mentioned.

In a preferred embodiment according to the invention, the step of drying in the pelletizer-dehydrator has a duration of 0.5 to 2 mn and allows for pellets whose moisture rate is comprised between 5 and 15%, preferably between 10 and 12%, to be obtained. Preferably, the duration of the drying step is 1 mn.

Thus, the process for manufacturing pellets according to the invention allows for 150 to 650 Kg of pellets to be manufactured per hour. It appears from the elements described above that the invention is economical in terms of energy, is fast, and allows for pellets with a high calorific value to be manufactured.

In order to optimize the production speed of the pellets, the process for manufacturing pellets according to the invention can comprise one or several pelletizer(s), each coupled, in a closed circuit, to one or several dehydrators. Thus, the biomass, wet and ground, is transported by a conveyor toward, for example, two pelletizers-dehydrators arranged symmetrical with respect to the tank containing the wet biomass. Two electric motors are thus necessary in this embodiment and the granules thus exit in a double stream. It is understood that it is possible to multiply the number of pelletizer-dehydrators downstream of the transporting of the wet biomass depending on the yield need.

In a preferred embodiment of the invention, the rotor of the pelletizer is fixed and maintained by a hydraulic nut. This hydraulic nut makes it possible to absorb thermal and mechanical shocks. The biomass loaded in the cylinder has, at ambient temperature, a high moisture level comprised between 25 and 80%. The mechanical assembly of the pelletizer, when in operation, can present a temperature of close to 95° C. In order to absorb distorsions due to thermal shock, a hydraulic nut is preferably used.

The rotor of the pelletizer is driven by one or two electric motors, each having a maximum power of about 40 KW, via a belt in an oil bath. In the case where two motors co-exist, the first electric motor has a power of 20 KW and the second electric motor a power of 40 KW. In the latter case, the total value is used only at the time the material is charged into the cylinder. From the first pelletizer-dehydrator cycle, the value is reduced and only the least powerful motor is operating.

The process for manufacturing pellets according to the invention has been made mostly to treat residues of wet biomass constituted of plants such as previously described, i.e., pruning, upkeep and waste by community organizations. As previously described, the process for manufacturing pellets according to the invention is also applicable to the residues of the wet biomass constituted of wood waste only. The process according to the invention makes it possible to manufacture pellets by treating residues of wet biomass having a moisture rate comprised between 25 and 80%, preferably about 50%.

When the wet biomass is constituted of fermenting vegetal homogenate intended for compost, the moisture rate is 80%. It is thus possible, by applying the process according to the invention, to manufacture, from the wet biomass, pellets having a mass density or compaction of 1000 Kg/m³. The denser the pellet, the greater the calorific value thereof. Consequently, the calorific value of the pellets obtained from the vegetal homogenate in fermentation intended to the compost is very high.

When the wet biomass is constituted of horse litter having a compaction of 665 Kg/m³, the process according to the invention makes it possible to manufacture pellets whose compaction is of 810 Kg/m³.

Thus, the process according to the invention makes it possible to manufacture pellets having a compaction greater than 750 Kg/m³ depending on the nature of the entering wet biomass.

When the residues of wet biomass entering the pelletizer are constituted of residues of plants comprising ligneous and herbaceous plants, the matrix of the pelletizer is pierced with holes having a 6 mm diameter.

When the residues of wet biomass entering the pelletizer are constituted of wood residues, the matrix of the pelletizer is pierced with holes having a diameter of 10 or 16 mm. A second object of the invention consists of a pellet manufactured by the process such as previously defined.

The pellet preferably has a diameter comprised between 6 and 16 mm and a moisture rate comprised between 5 and 15%, preferably 10%.

The pellet according to the invention has a calorific value comprised between 17.00 and 20.9 kJ/kg, a durability greater than 92%, an oxygen rate of about 38%, and comprises less than 2% of undesirable particles.

By applying the process according to the invention, some pellets with very high calorific value have a compaction greater than 750 Kg/m³, preferably a compaction comprised between 810 and 1000 Kg/m³.

### EXAMPLE 1

Process for manufacturing pellets having a 6 mm diameter from residues of vegetal biomass.

1. Fresh vegetal waste, constituted in part of ligneous matter, at a level of about 40/50%, is crudely ground. The moisture rate of the biomass is 55% and the compaction 160-180 Kg/m³.

2. The homogenate is cleaned of undesirable matters, then put through a fine grinder to obtain a granularity of about 10 mm.

3. The fine homogenate is loaded into the pelletizer-dehydrator by means of an auger actuated by a timer for quantifying the matter load.

The pelletizer is a simple pelletizer simple of the Kahl® type to which a hydraulic nut was adapted. The space between the wheels of the rotor and the matrix is less than 1/10 mm.

The speed of the rotor on the matrix is of about 350 to 450 revolutions/minutes.

The dehydrator is an assembly of streamlined metal composed of steel buckets for collecting the biomass extruded through the matrix of the pelletizer. The buckets are fixed to a synthetic belt driven by an electric motor such as a conveyor. A hole at the top of the assembly enables the evacuation of steam. The opening in the lower portion allows the biomass, originating from the matrix, to enter the dehydrator. Another opening in the upper portion enables the matter to return toward the cylinder bell. The centrifugal force allows for the product thus transported to be pushed back toward the cylinder. The distance H of the travel of the pellets in the dehydrator is about 350 cm.

The loaded matter immediately comes in contact with the walls of the cylinder and rotor which are brought to a high temperature, thus drying the matter. The temperature is obtained by friction of metals together and is returned to the material by convection, then by mechanical action (pelletization), and subsequently by convection in the dehydrator.

4. The matter is allowed to recycle for one minute in the pelletizer-dehydrator until a compact pellet is obtained.

5. The obtained pellet is drained down and the fine homogenate is simultaneously loaded. The by-pass thus removes the loading part and the two materials cannot mix.

### EXAMPLE 2

Pellet obtained by the process of the invention.

The pellets obtained by the process according to example 1 have the following characteristics:

Diameter: 6 mm

Gross moisture: 12%

Mechanical strength: 99%

Inferior calorific value: 18.96 kJ/kg

Mass density: 665 Kg/m³

Quantity of fines: 0.1%

Rate of ash: 5.7%

### EXAMPLE 3

Process for manufacturing pellets having a 6 mm diameter from fermenting vegetal homogenate intended for compost.

The wet biomass in this example presents a moisture rate of 80% and a mass density of 330 Kg/m³. After having carried out the steps described in example 1, pellets having a 6 mm diameter and a compaction of 1000 Kg/m³ are obtained.

### EXAMPLE 4

Process for manufacturing pellets having a 6 mm diameter from horse litter. With a wet biomass having a compaction of 665 Kg/m³, the process according to the invention such as described in example 1 makes it possible to obtain pellets of 810 Kg/m³.

1. Method for manufacturing pellets from residues of wet biomass having a high moisture ratio comprised between 25 and 80% comprising the following steps:
a) loading the homogenate of the residues of wet biomass in a receptacle,
b) drying the residues of wet biomass, and
c) transforming the dry biomass residues in a pelletizer comprising a steel matrix pierced with holes and a steel rotor comprising steel notched wheels for obtaining pellets whose moisture ratio is comprised between 5 and 15%,
characterized in that the step of drying residues of wet biomass is carried out simultaneously with the step of transformation into pellets at a temperature comprised between 65 and 95° C. obtained by rotation of the steel notched wheels on the steel matrix in a pelletizer coupled, in closed circuit, to an air/air exchange dehydrator located downstream of the pelletizer and comprising a pelletizer-dehydrator communication by-pass.

2. Method according to claim 1, characterized in that the step of drying, simultaneous with the step of transforming residues into pellets in the pelletizer, is carried out with a rotor speed on the matrix comprised between 350 and 450 revolutions/minutes and a space between the rotor wheels and the matrix less than or equal to 1/10 mm.

3. Method according to claim 1, characterized in that air/air exchange dehydrator is coupled to the pelletizer so as to lower by 8 to 15% the temperature of the incoming pellets, so as to re-inject them into the pelletizer by the communication by-pass.

4. Method according to claim 1, characterized in that the matrix is pierced with holes having a diameter comprised between 6 and 16 mm.

5. Method according to claim 1, characterized in that the rotor of the pelletizer is fixed and maintained by a hydraulic nut.

6. Method according to claim 1, characterized in that the wet biomass is constituted of residues of plants and/or wood.

7. Method according to claim 1, characterized in that the wet biomass entering the pelletizer is constituted of plant residues comprising ligneous and herbaceous plants, and in that the matrix of the pelletizer is pierced with holes having a 6 mm diameter.

8. Method according to claim 1, characterized in that the wet biomass entering the pelletizer is constituted of wood residues, and in that the matrix of the pelletizer is pierced with hole having a 10 or 16 mm diameter.

9-10. (canceled)
